(19) United States
(12) Patent Application Publication
(10) Pub. No.: US 2009/0212657 A1
(43) Pub. Date: Aug. 27, 2009

(54) EQUIVALENT-CAPACITANCE TYPE ACTUATOR DRIVE DEVICE

(75) Inventor: Takeshi Mizuno, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NATIONAL UNIVERSITY CORPORATION SAITAMA UNIVERSITY, Saitama-City, Saitama (JP)

(21) Appl. No.: 11/815,635

(22) PCT Filed: Jan. 31, 2006
(86) PCT No.: PCT/JP2006/301557

§ 371 Date: Apr. 28, 2009

(30) Foreign Application Priority Data
Feb. 7, 2005 (JP) 2005-030095
May 25, 2005 (JP) 2005-153147

(51) Int. Cl. H02N 11/00

(52) U.S. Cl. 310/300

(57) ABSTRACT

[Problem]To provide an actuator drive device that eliminates the need for high voltage amplifiers.

[Means for Solving Problem]The electrostatic actuator drive device comprises a variable capacitor 12 connected in series with an electrostatic actuator 10, and a constant voltage source 11 for applying a constant voltage between the both ends of the serial connected electrostatic actuator 10 and the variable capacitor 12. The capacitance of the variable capacitor 12 is varied under control of a controller 14 for adjusting the voltage to be applied to the electrostatic actuator 10. The constant voltage source 11 may be any forms to apply a constant high voltage. The electrostatic actuator 10 is equivalently a capacitor. In this device, the capacitance of one of series connected two capacitors is varied for adjusting the voltage to be applied to the other capacitor, or the electrostatic actuator 10. The drive device does not use expensive high voltage amplifiers, is simple in construction and is able to quickly control the voltage to be applied to the electrostatic actuator 10.

### FIELD OF THE INVENTION

The present invention relates to a drive device such as an electrostatic actuator utilizing electrostatic force, a piezoelectric actuator utilizing reverse piezoelectric effect or the like, more specifically to a low cost drive control for such actuator.

### BACKGROUND OF THE INVENTION

Electrostatic actuators have been used for the purpose of floating or lifting articles, moving articles or sucking articles by utilizing electrostatic force.

The principle of an electrostatic floating device that utilizes an electrostatic actuator is described in, for example, a Patent Document 1 as listed hereunder or the like. As illustrated in FIG. 27, this device comprises a stator 810 made of an insulating substrate, a plurality of electrodes 811-818 formed on the stator 810, a floating member 820 to float by the action of electrostatic force, displacement sensors 830-833 for detecting distances (or gaps) from the floating member 820, a controller 840 for generating control voltage, and high voltage amplifiers 870-873 for amplifying the control voltage to be applied to each of the electrodes 811-818.

A floating force is exerted on the floating member 820 that is opposed to the stator 810 by the high voltage applied to the electrodes 811-818. The sensors 830-833 detect the gap of the floating member 820 and output detection signals to the controller 840. Then, the controller 840 compares the detection signals with a target value for generating control voltages for stably floating the floating member 820 that are outputted to the high voltage amplifiers 870-873. After being amplified by the high voltage amplifiers 870-873, the control voltages are applied to the electrodes 811-818 on the stator 810, thereby stably floating the floating member 820.

As for the principle of a floating electrostatic transportation device using an electrostatic actuator is described in, for example, a Patent Document 2 as listed hereunder or the like. FIG. 28 (a) is a side view of such device and FIG. 28 (b) is a plan view for illustrating electrodes that are formed on a stator.

This device comprises a stator 910 made of an insulating substrate, comb-like electrodes 911a-930a, 911b-930b formed on the stator 910, a member to be transported 950 that is floated and transported by the action of electrostatic force, and displacement sensors 991-998 for detecting the location of the member to be transported 950.

In this device, based on the location of the member to be transported 950 that is detected by the displacement sensors 991-998, a voltage is applied to the electrodes 911a-918a, 911b-918b immediately above the member to be transported 950 for floating it by electrostatic force. At this time, the voltage to be applied to the electrodes 911a-918a, 911b-918b is controlled for making adjustment of the distance between the member to be transported 950 and the stator 910 as well as the slope of the member to be transported 950.

Subsequently, the voltage is applied to the electrodes 919a, 919b locating at the adjacent location in the moving direction of the member to be transported 950 and simultaneously the voltage applied to the electrodes 911a, 911b that are no longer located above the member to be transported 950 is shut off. Then, the member to be transported 950 moves in the right direction by one pitch. The above operation is sequentially repeated for transporting the member to be transported 950 in the right direction while it is in the floating condition.

This device is contamination free to environment because it is a non-contact transportation means and is best suited for holding and transporting such members as silicon wafers, aluminum discs or the like in a clean room. Moreover, since the electrostatic actuator is simple in construction and a higher output per unit weight can be expected when the actuator becomes increasingly smaller, it attracts high attention as applications to actuators for micro-machines.

On the other hand, a piezoelectric actuator is an actuator to use the property of a piezoelectric element that expands or contracts upon application of electric field as disclosed in a Patent Document 3 or the like that is listed hereunder and finds applications for precise alignment of an article. A piezoelectric element (also known as an electrostrictive element) is quickly responsive to applied voltage and displaces precisely. However, it produces relatively large strain but causes relatively small amount of displacement. Accordingly, in case of requiring relatively large amount of displacement, it is typical to use a laminated piezoelectric element in which a plurality of piezoelectric layers sandwiched between electrodes are laminated. By utilizing the high speed response and precise displacement properties of such piezoelectric element, a piezoelectric actuator finds applications in microscopic position control of a semiconductor fabrication machine, a driving source for a high speed printer or the like. It also attracts attention as key devices in micro-mechatronics (or electro-mechanics).

### Patent Document 1: JP H09-322564 (A)

### Patent Document 2: JP H10-112985 (A)

### Patent Document 3: JP 2004-280355 (A)

### DISCLOSURE OF THE INVENTION

### Problems to be Solved by the Invention

Since the upper limit of the available force per unit area of the electrostatic force is only fractional as compared to a magnetic force, it is necessary to apply high voltage in the order of kilo volts to the electrodes in case of non-contact floating of an article using such electrostatic force. Moreover, it is necessary to quickly change such voltage for stabilizing or transporting the floating article.

In a conventional electrostatic actuator, it is required to user highly precise and large-scale high voltage amplifiers for obtaining voltages to be applied to such electrodes in order to meet these requirements.

Additionally, in a piezoelectric element, it is required to apply an electric field in the range of about 1000V/mm in order to develop a strain of about 1/1000 of its total length. This means that a high voltage in the order of kilo volts is required for causing large displacement using a laminated piezoelectric element.

Accordingly, in a conventional piezoelectric actuator, highly precise and large-scale high voltage amplifiers are used in order to generate such high voltages and for quickly and dynamically changing such voltages.

Apparently, such types of amplifiers are very expensive and prevent the use of equivalent-capacitance-type actuators such as electrostatic actuators, piezoelectric actuators, or the like, which can be treated as capacitors in electric circuits.

In view of the foregoing problems associated with the prior art, it is an object of the present invention to provide an equivalent-capacitance-type actuator drive device that eliminates the need for such high voltage amplifiers.

### Means to Solve the Problems

The equivalent-capacitance-type actuator drive device according to the present invention comprises a variable capacitor connected in series with an equivalent-capacitance-type actuator and a constant voltage source for applying a voltage between both ends of the equivalent-capacitance-type actuator and the variable capacitor connected in series, wherein the capacitance of the variable capacitor is varied for making adjustment of the voltage to be applied to the equivalent-capacitance-type actuator.

The constant voltage source to be used in this device is only required to generate a constant DC high voltage or an AC high voltage having constant amplitude. The equivalent-capacitance-type actuator is equivalently a capacitor. In this device, the capacitance of one of the two capacitors connected in series with each other is varied for making adjustment of the voltage to be applied to the other capacitor or the equivalent-capacitance-type actuator.

The equivalent-capacitance-type actuator drive device according to the present invention is also provided with an additional capacitor having a large capacitance that is connected in parallel with the constant voltage source.

The additional capacitor supplies to or absorbs from the equivalent-capacitance-type actuator movable charge that is necessary to change the voltage to be applied to the equivalent-capacitance-type actuator. As a result, it is possible to instantly change the voltage to be applied to the equivalent-capacitance-type actuator without any influence of the internal resistance of the constant voltage source.

In the present invention, either an electrostatic actuator or a piezoelectric actuator is used as the equivalent-capacitance-type actuator.

The driving of such electrostatic actuator or piezoelectric actuator is carried out without using expensive high voltage amplifiers.

The equivalent-capacitance-type actuator drive device according to the present invention further comprises driving means for varying the capacitance of the variable capacitor in response to a control signal. It is the driving means that changes the distance between electrodes of the variable capacitor.

The variable capacitor may be implemented in various configurations. For example, the driving means may be one to vary the opposed area between electrodes of the variable capacitor, one to vary the strain to be applied to the piezoelectric material between electrodes of the variable capacitor, or one having a movable member for forming a capacitance between electrodes of the variable capacitor, thereby differentially varying the capacitance between a plurality of electrodes.

It is also possible to implement the variable capacitor using a plurality of fixed capacitors and switches for periodically making or breaking the parallel connection of one part of the fixed capacitors. The ratio of ON (turn-on) and OFF (turn-off) time durations of the switches is controlled for changing the combined capacitance of the plurality of fixed capacitors.

### ADVANTAGES OF THE INVENTION

The equivalent-capacitance-type actuator drive device according to the present invention is able to quickly control the voltage to be applied to an electrostatic actuator, a piezoelectric actuator or the like with a simple construction and without using expensive high voltage amplifiers.

### BEST MODES OF IMPLEMENTING THE INVENTION

### First Embodiment

FIG. 1 shows one embodiment of an electrostatic actuator drive device according to the present invention. This device comprises an electrostatic actuator 10 having a stator 40 and pairs or electrodes 81a-81b, 82a-82b, 83a-83b and 84a-84b, variable capacitors 212-215 connected in series between one electrodes 81a, 82a, 83a and 84a and the other electrodes 81b, 82b, 83b and 84b of the electrode pairs, and a constant voltage source 112. Moreover, it comprises a controller 14 for making adjustment of the variable capacitors 212-215 in response to the condition of the electrostatic actuator 10. In this device, the capacitance of the variable capacitors 212-215 is varied for making adjustment of the voltage to be applied to the electrostatic actuator 10.

The electrostatic actuator can be handled electrically equivalent to a capacitor. For example, as shown in FIG. 3 (a), in case of an electrostatic actuator of a configuration including a floating member 13 opposed to an electrode pair 2a, 2b formed on a stator 4, a virtual capacitor 9 is formed between electrode terminals 5a, 5b as shown in FIG. 3 (b).

Accordingly, the drive device is shown by an equivalent circuit comprising a variable capacitor C1 and an electrostatic actuator C2 as shown in FIG. 2. That is, the capacitors C1 and C2 are connected in series with each other and the plus side (+) of a DC constant voltage source E is connected to the capacitor C1 while connecting the minus side (−) of the DC constant voltage source E to the capacitor C2, which may be grounded if necessary.

In the equivalent circuit as shown in FIG. 2, let voltages between both terminals of the capacitors C1 and the capacitor C2 be respectively V1 and V2, the voltages V1 and V2 are given by the following Formulas 1 and 2:

V1={C2/(C1+C2)}E (Formula 1)

V2={C1/(C1+C2)}E (Formula 2)

On the other hand, charges Q1 and Q2 in the capacitors C1 and C2 are given by the following Formula 3:

Q1=Q2={C1*C2/(C1+C2)}E (Formula 3)

(It is assumed that Q1=Q2=Q.)

Under the above condition, it is assumed that the capacitance of the capacitor C1 is varied from C1 to C1+ΔC1 and the varied capacitance is indicated with “′”, i.e., C1+ΔC1=C1′. Then, charge Q in the capacitors C1 and C2 varies as given by the following Formula 4:

$$\begin{matrix}{Q}^{′} = Q + Δ Q \\ = \{ C {1}^{′} \cdot C 2 / ( C {1}^{′} + C 2 ) \} E\end{matrix} \qquad ( Formula 4 )$$

As a result the voltage V2 to be applied to the electrostatic actuator is given by the following Formula 5:

$$\begin{matrix}V {2}^{′} = V 2 + Δ V 2 \\ = \frac{{Q}^{′}}{C 2} \\ = \frac{C {1}^{′}}{C {1}^{′} + C 2} E \\ = \frac{C 1 ( 1 + \frac{Δ C 1}{C 1} )}{( C 1 + C 2 ) ( 1 + \frac{Δ C 1}{C 1 + C 2} )} E \\ ≅ ( 1 + \frac{C 2}{C 1 + C 2} \cdot \frac{Δ C 1}{C 1} ) V 2\end{matrix} \qquad ( Formula 5 )$$

As understood from the above, when the capacitance of the capacitor C1 varies, the voltage V2 to be applied to the electrostatic actuator immediately changes to V2′.

Accordingly, by using the high voltage source that generates a DC constant voltage in the order of kilo volts as the constant voltage source E, it is possible to apply the voltage required for electrostatic floating and electrostatic floating and transportation to the electrodes of the electrostatic actuator C2.

As described hereinabove, the variable capacitor C1 in the drive device may take various forms.

A variable capacitor structure as illustrated in FIG. 4 (a) comprises a multi-stage capacitor including elastic dielectric members 31 and electrodes 2 alternately laminated between bases 401, 402, and an actuator 1 having a variable stroke in a straight direction 18. The multi-stage capacitor forms a virtual capacitor 9 as illustrated in FIG. 4 (b) having a pair of electrode terminals 5a, 5b one of which is connected to the electrostatic actuator C2 while the other is connected to the plus (+) side of the power supply E.

A control signal for controlling the voltage to be applied to the electrostatic actuator C2 is inputted to the actuator 1 from a controller 14. The actuator 1 extends or contracts its stroke in the straight direction 18 in response to the control signal, thereby changing the distance between electrodes in the multi-stage capacitor for varying its capacitance and making adjustment of the voltage to be applied to the electrostatic actuator C2.

It is to be noted that an amplifier (not shown) was normally used for driving the actuator 1: However, such amplifier (not shown) for driving the actuator 1 could be a low cost one because the amplifier does not need to directly control the high voltage.

A variable capacitor structure as shown in FIG. 5 has a capacitor comprising a fixed electrode 201 mounted on a base 401, a movable electrode 202 that is moved by the actuator 1, and a dielectric member interposed between the both electrodes. This capacitor varies the opposed area between the fixed electrode 201 and the movable electrode 202 depending on extending and contraction of the actuator 401 mounted on the base 402, thereby varying its capacitance.

A variable capacitor structure as shown in FIG. 6 has a multi-stage capacitor comprising a dielectric member 31 and the electrodes 2 accommodated in a container made of a bottom plate 403 and a cover member 404 that are jointed together with an elastic member 11. An electromagnetic actuator 10 is mounted on the cover member 404, while a target 12 for the electromagnetic actuator 10 is mounted on the bottom plate 403. In this device, a control signal for controlling the voltage to be applied to the electrostatic actuator C2 is supplied to the electromagnetic actuator 10 from the controller 14. An attracting force of the electromagnetic attracts the bottom plate 403 having the target 12 mounted thereon toward the cover member 404, thereby changing the distance between electrodes of the multi-stage capacitor and varying its capacitance.

A variable capacitor structure as shown in FIG. 7 is a variable capacitance comprising movable electrodes 202 mounted on a rotary shaft of a rotary type actuator 71 such as a motor or the like and fixed electrodes 201. In this device, the rotary type actuator 71 rotates by a predetermined angle upon receiving a control signal from the controller 14, thereby changing the opposed area of the fixed electrodes 201 and the movable electrodes 202 and varying its capacitance.

A variable capacitor structure as shown in FIG. 8 comprises a piezoelectric member 80, the electrodes 2 formed on both surfaces thereof, and an actuator 1 for applying stress to the piezoelectric member 80. In this device, a control signal is inputted to the actuator 1 from the controller 14. When the actuator extends or contracts its stroke in response to the control signal, stress to be applied to the piezoelectric member 80 changes, thereby varying the voltage between the electrodes 2.

A variable capacitor structure as shown in FIG. 9 (a) is a differential type capacitor constituting virtual capacitors 90 (i.e., a virtual capacitor 90a and a virtual capacitor 90b) by two fixed electrodes 201a, 201b and a movable electrode 202 as shown in FIG. 9 (b). In the differential type variable capacitor structure, when the movable electrode 202 moves by extending or contraction of the actuator 1, one of the virtual capacitors 90a, 90b decreases its capacitance, while the other virtual capacitor increases its capacitance.

The differential type variable capacitor structure is suitable for driving a differential type electrostatic actuator. For example, a differential type electrostatic actuator as illustrated in FIG. 10 (a) comprises electrodes 8a, 8b provided on both surfaces of an insulating member 100, one of the electrodes (electrode 8a) facing opposed electrodes 2a, 2b of a stator 4, while the other electrode (electrode 8b) facing opposed electrodes 3a, 3b of the opposite stator 6 for extending the floating insulating member 100 from the both ends thereof. In this differential type electrostatic actuator, a pair of virtual capacitors 9a, 9b are formed as shown in FIG. 10 (b).

By combining the differential type actuator and the differential type capacitor structure as shown in FIG. 9 (c), the movable electrode 202 of the differential type variable capacitor structure and the electrodes 2b, 3b of the differential type electrostatic actuator are connected by way of a constant voltage source 112 and the fixed electrodes 201a, 201b of the differential type variable capacitor structure are connected to the electrodes 2a, 3a of the differential type electrostatic actuator, respectively. Advantageously, the pair of the virtual capacitors 9a, 9b of the differential type electrostatic actuator can be driven by a single variable capacitor structure.

FIG. 11 shows a rotary differential type variable capacitor structure constituting a differential capacitor comprising a pair of split fixed electrodes 201a, 201b, and a variable electrodes 202 mounted on a rotary shaft of a rotary type actuator 71. Similar to the variable capacitor structure as shown in FIG. 9, the rotary differential type variable capacitor structure can be used in combination with a differential type electrostatic actuator.

FIG. 12 illustrates an exemplified circuit of constituting a variable capacitor. This circuit comprises a parallel connection of fixed capacitors C11 and C12 and a switch SW1 for making (ON) or breaking (OFF) the connection of one fixed capacitor C12. As illustrated in FIG. 13, the switch SW1 is repeatedly turned ON and OFF at the frequency f so that it is ON for only a time duration t1 but OFF in the remaining time duration t2 of a period. An effective combined capacitance between the both terminals 5a, 5b of this circuit is varied depending on the ratio of the time duration t1 and t2.

As appreciated from the above descriptions, the high voltage source to be used in the electrostatic actuator drive device may be any source of supplying a constant high voltage. And the variable capacitor may be configured by various mechanical capacitance variable means utilizing various actuators or by capacitance variable means in circuitry. Any low cost amplifier may be used for driving the actuator in the mechanical capacitance variable means because it does not directly control the high voltage.

FIG. 14 illustrates experiment equipment that is used for measuring the change in force (electrostatic force) generated by the electrostatic actuator in response to the capacitance variation of the variable capacitor. The experiment equipment comprises an electrically conductive plate 63 mounted on supporting posts 67, a movable plate 64 opposed to the conductive plate 63 by way of an insulating film (a dielectric layer) 65, a conductive plate 62 disposed at the opposite surface to the conductive plate 63, a positioning stage 66 for adjusting the vertical position of the conductive plate 62, and lead wires 61 through which a constant voltage is applied between the movable plate 64 and the conductive plate 62.

The conductive plate 63 is mounted on the supporting posts 67 in an insulating manner. The movable plate 63 is mounted at a torsion spring portion so that the other end portion 69 is lifted from the insulating film 65 by elasticity of the torsion spring. The movable plate 64, the insulating film 65 and the conductive plate 63 constitute the electrostatic actuator and the vertical position of the other end portion 69 of the movable plate 64 can be controlled by the electrostatic force developed between the conductive plate 63 and the movable plate 64.

On the other hand, the conductive plate 62 is mounted on the positioning stage 66 by way of the insulating layer 68. The conductive plate 62 and the conductive plate 63 constitute a variable capacitor mechanism. Its capacitance is adjusted by changing the gap between the conductive plate 62 and the conductive plate 63 by the positioning stage 66.

FIG. 15 is an equivalent circuit of the experiment equipment. Let the voltage applied across both ends of the equivalent circuit, the capacitance of the variable capacitor comprising the electrodes 62 and 63, and the capacitance of the capacitor comprising the electrodes 63 and 64 be respectively E (E=1kV in this particular case), C1 and C2, the voltage between the electrodes 63 and 64 constituting the electrostatic actuator is:

V2={C1/(C1+C2)}E

as given by Formula 2. And the electrostatic attraction force (propelling power) F applied to the movable plate 64 is theoretically proportional to the second power of V2.

FIG. 16 shows the actual measurement results of the attraction force (propelling power) as measured by the experiment equipment. The horizontal axis represents capacitance of the variable capacitor C1, while the vertical axis represents the propelling power. It is understood that the propelling power increases as the capacitance of the variable capacitor C1 increases.

FIG. 17 illustrates experiment equipment that is used for measuring the change in electrostatic force of the electrostatic actuator when the capacitance of the variable capacitor changes in time. In this device, a variable capacitor 600 comprises a fixed electrode 601 and a movable electrode 602, while an electrostatic actuator 700 comprises a fixed electrode 701 and a variable electrode 702. And the variable electrode 602 of the variable capacitor 600 and the variable electrode 702 of the electrostatic actuator 700 are connected together and the constant voltage source E 11 is interposed between the fixed electrode 601 of the variable capacitor 600 and the fixed electrode 701 of the electrostatic actuator 700 in order to constitute the equivalent circuit in FIG. 2.

The movable electrode of the variable capacitor 600 is mounted on a movable portion of a VOC (Voice Coil Motor) 603 and the distance between the movable electrode 602 and the fixed electrode 601 changes periodically in response to the movement of the movable portion. The distance between the movable electrode 602 and the fixed electrode 601 is measured using a gap sensor 604.

On the other hand, the movable electrode 702 of the electrostatic actuator 700 is mounted on a load cell 703 for measuring the weight. The magnitude of electrostatic force to be applied to the variable electrode 702 is extracted after conversion into an electric signal by the load cell 703.

FIG. 18 (a) is a graph showing the change in the distance Gap (unit: mm) between the movable electrode 602 and the fixed electrode 601 and the change in capacitance Cv (unit: pF) of the variable capacitor 600 when the VOC 603 is driven at the frequency of 1 Hz. On the other hand, FIG. 18 (b) is a graph to show how electrostatic force Ef (unit: N) in the electrostatic actuator 700 changes at that time.

It is to be noted in this example that the voltage of the constant voltage source E11 is 1 kV and the capacitance Ca of the electrostatic actuator 700 is 200 pF. In the graph in FIG. 18 (b), 1 division of the horizontal axis represents 0.5 second.

FIG. 19 is a graph showing in combination the waveform of the distance between electrodes (Gap) of the variable capacitor 600 as shown in FIG. 18 (a) and the electrostatic force (Ef) in the electrostatic actuator 700 as shown in FIG. 18 (b).

It is appreciated from FIG. 19 that the electrostatic force in the electrostatic actuator 700 follows the change in capacitance of the variable capacitor 600. This means that the voltage to be applied to the electrostatic actuator 700 and the electrostatic force therein can be controlled quickly by varying the capacitance of the variable capacitor 600.

Now, FIG. 20 illustrates an example of applying the drive device to an electrostatic floating transportation mechanism.

This mechanism comprises comb-like electrodes 103 formed on a base 109, a member to be transported 104 that is transported while floating by the action of the electrostatic force, displacement sensors 105 for detecting the location of the member to be transported 104, a variable capacitor configuration comprising the variable capacitor 102 and the actuator 101, a controller 107 for controlling the operation of the mechanism, a sensor combiner 106 for combining signals from the displacement sensors 105, and distributors 108 for applying control voltages to the electrodes 103.

The comb-like electrodes 103 comprise alternately disposed electrodes, one being connected to the minus side (−) of the constant voltage source 110 and grounded, while the other being connected to the distributors 108. As shown in FIG. 28 (b), the comb-like electrodes 103 are disposed in two rows. It is possible to configure so that, if electrodes in one row are connected to the constant voltage source 110, the adjacent electrodes in the other row are connected to the distributors 108.

The electrodes 103 to be connected to the constant voltage source 110 and the electrodes 103 to be connected to the distributors 108 together with the member to be transported 104 constitute the capacitor in FIG. 3. On the other hand, the distributors 108 are connected to the fixed electrodes of the variable capacitor 102. The movable electrode of the variable capacitor 102 is connected to the plus (+) side of the constant voltage source 110. As a result, the equivalent circuit of this mechanism is the same as FIG. 2.

The member to be transported 104 floats by the electrostatic force of the electrodes 103 to which the voltage from the distributors 108 is applied. The displacement sensors 105 detect the distance to the member to be transported 104 and output the detection signals 111 to the sensor combiner 106 which combines the detected signal from each displacement sensors 105 to be outputted to the controller 107 and the distributors 107.

The controller 107 makes a judgment whether the slope of the member to be transported 104 and the distance or the gap between the member to be transported 104 and the base 109 is appropriate or not. If any modification is necessary, a driving signal 113 is sent to the actuator 101 of the variable capacitor mechanism for driving the actuator 101 in order to vary the capacitance of the variable capacitor 102, thereby adjusting the voltage to the fixed electrode of the variable capacitor 102.

Also, the controller 107 makes judgment from the detected signals of the displacement sensors 105 of the electrodes 103 that requires voltage application and the electrodes 103 that voltage application should be interrupted for transporting the member to be transported 104 from the detection signals from the displacement sensors 105. And the control signal 112 is sent to the distributors 108 for instructing voltage application to or interruption from the electrodes 103.

The distributors 108 changes the electrostatic force to act on the member to be transported 104 by applying the voltage that is designated by the controller 107 to the electrode 103 at the fixed electrode side of the variable capacitor 102.

By repeating the above operation, the member to be transported 104 is stably transported under the floating condition.

As appreciated from the above descriptions, the drive device according to the present invention is able to drive an electrostatic actuator that performs electrostatic floating, electrostatic floating and transportation or the like without suing expensive high voltage amplifiers.

The drive device according to the present invention can also be applied to a piezoelectric actuator.

FIG. 21 illustrates an embodiment of driving a piezoelectric actuator using a constant voltage source 52 and a variable capacitor 53. The piezoelectric actuator comprises a piezoelectric element 50 and a base 51 for supporting the piezoelectric element 50. For example, the piezoelectric element 50 is a laminated piezoelectric element comprising a large number of laminated piezoelectric members 502 sandwiched between electrodes 501 as shown in FIG. 22. The electrodes 501 are electrically connected to terminals that are provided on the base 51 to constitute an equivalent capacitor with the opposed electrodes 501 and the piezoelectric members 502. Each of the piezoelectric members 502 stretches or expands in the direction as indicated by an arrow in response to the voltage between the opposed electrodes 501 and such expanding force of each piezoelectric member 502 is integrated to provide displacement of the laminated piezoelectric element.

The drive device for a piezoelectric actuator is shown by an equivalent circuit in FIG. 23. As a result, similarly to the case of the electrostatic actuator, a high voltage source for generating a constant DC voltage in the order of kilo volts is used as the constant voltage source E (52) and the capacitance of the variable capacitor C1 (53) is controlled for applying the voltage required by the piezoelectric element for developing a desired displacement to the electrode of the piezoelectric actuator C2 (50).

Again, the variable capacitor 53 may be any one of the variable capacitors as shown in FIGS. 4, 5, 6, 7, 8, 11 and 12.

Although the DC voltage source having a constant voltage is used herein as the constant voltage source, it is possible to replace it by an AC voltage source having constant amplitude.

### Second Embodiment

A second embodiment according to the present invention is a quickly responsive drive device, wherein the voltage to be applied to an electrostatic actuator or a piezoelectric actuator can be varied quickly even if the constant voltage source may have an internal resistance.

In case of the equivalent circuit as shown in FIG. 2 (or FIG. 23), when the capacitance of the capacitor C1 changes, the voltage V2 to be applied to an electrostatic actuator (or a piezoelectric actuator) C2 immediately changes to the voltage V2′ given by Formula 5.

However, if there is an internal resistance in the voltage source E, its equivalent circuit is as shown in FIG. 24 (note that the internal resistance in the voltage source E is as 2R). Charges to be supplied to the capacitors C1, C2 from the voltage source E or charges to flow from the capacitors C1, C2 into the voltage source E are limited, thereby disabling to quickly change the voltage to be applied to the electrostatic actuator (or the piezoelectric actuator) C2 even if the capacitance of the capacitor C1 varies.

In this embodiment of the drive device, such problem is solved by interposing a capacitor C3 having a large capacitance in parallel with the voltage source E as shown in FIG. 25, thereby ensuring quick response.

The capacitor C3 supplies to or absorbs from C2 moving charges that are necessary to change the voltage to be applied to an electrostatic actuator (or a piezoelectric actuator). Since such operation is basically moving charges from one capacitor to another capacitor, there is essentially no time delay in the change of the voltage to be applied to an electrostatic actuator (or a piezoelectric actuator) C2.

The aforementioned aspect will be described further hereunder.

In case of the equivalent circuit as shown in FIG. 25, the voltage V1 between terminals of the capacitor C1 and the voltage V2 between terminals of the capacitor C2 under the steady state are given by the following Formula 1 and Formula 2:

V1={C2/(C1+C2)}E (Formula 1)

V2={C1/(C1+C2)}E (Formula 2)

On the other hand, the charges Q1 in the capacitor C1 and the charges Q2 in the capacitor C2 are given by the following Formula 3 and the charges Q3 in the capacitor C3 are given by the following Formula 6:

Q1=Q2={C1*C2/(C1+C2)}E=Q (Formula 3)

Q3=C3·E (Formula 6)

It is assumed in the above condition that the capacitance of the capacitor C1 is varied from C1 to C1′=C1+ΔC1. Although charges move instantly between capacitors, charges move slowly from the voltage source E because charges must flow through the resistor R. As a result, when discussing the operation immediately after varying the capacitance of the capacitor C1, charges moving from the voltage source E can be neglected and the equivalent circuit in this condition can be the one as shown in FIG. 26.

Let the voltage between the terminals and the charges of the capacitor C3 be respectively V3′ and Q3′ after varying the capacitance of the capacitor C1 from C1 to C1′=C1+ΔC1, charges Q1′ and Q3′ are given by the following Formula 7 and Formula 8:

Q1′=Q2′={C1′C2/(C1′+C2)}V3′=Q′ (Formula 7)

Q3′=C3·V3′ (Formula 8)

By applying the charge preservation rule, there exists the relationship given by the following Formula 9:

Q+Q3=Q′+Q3′ (Formula 9)

The above formula can be rewritten as the following Formula 10:

$$( 1 + C 3 \frac{C 1 + C 2}{C 1 C 2} ) Q = ( 1 + C 3 \frac{C {1}^{′} + C 2}{C {1}^{′} C 2} ) {Q}^{′} \qquad ( Formula 10 )$$

The Formula 10 can be further rewritten as the following Formula 11:

$$( \frac{1}{C 1} + \frac{1}{C 2} + \frac{1}{C 3} ) Q = ( \frac{1}{C {1}^{′}} + \frac{1}{C 2} + \frac{1}{C 3} ) {Q}^{′} \qquad ( Formula 11 )$$

Assuming that C3>>C1 and C3>>C2, then the above Formula 11 is given by the following Formula 12:

$$( \frac{1}{C 1} + \frac{1}{C 2} ) Q ≅ ( \frac{1}{C {1}^{′}} + \frac{1}{C 2} ) {Q}^{′} \qquad ( Formula 12 )$$

As a result, the V2′ can be given by the following Formula 13:

$$\begin{matrix}V {2}^{′} = \frac{{Q}^{′}}{C 2} \\ = \frac{\frac{1}{C 1} + \frac{1}{C 2}}{\frac{1}{C {1}^{′}} + \frac{1}{C 2}} \cdot \frac{Q}{C 2} \\ = \frac{1}{\frac{1}{C {1}^{′}} + \frac{1}{C 2}} E \\ = \frac{C {1}^{′}}{C {1}^{′} + C 2} E\end{matrix} \qquad ( Formula 13 )$$

As apparent from comparison between Formula 13 and Formula 5, there exists the same relationship as FIG. 2. In other words, it is possible to drive an electrostatic actuator (or a piezoelectric actuator) without any influence of the internal resistance or capacitance of the voltage source E.

It is to be noted here that the scheme of the present invention cannot be applied to prior art driving scheme of an electrostatic actuator (or a piezoelectric actuator) using an amplifier. If a capacitor having a large capacitance is connected in parallel with an electrostatic actuator (or a piezoelectric actuator), such capacitor becomes a part of the load of the amplifier, thereby degrading the operation characteristic.

That is, in a prior art for driving an electrostatic actuator (or a piezoelectric actuator) using an amplifier, the maximum output current of the amplifier determines quickness in response. On the other hand, in the embodiment of the drive device, even if a DC voltage source having a small maximum output current may be used, an excellent operation characteristic is guaranteed by the capacitor having a large capacitance that is connected in parallel with the voltage source.

Although it has been described in each embodiment that the equivalent-capacitance-type actuator is either an electrostatic or a piezoelectric actuator, it is possible to apply the present invention to other equivalent-capacitance-type elements, for example, liquid crystal panels as long as they are driven by high voltage.

### INDUSTRIAL APPLICABILITY

Since the drive device according to the present invention enables to drive an electrostatic actuator, a piezoelectric actuator or the like at a low cost, it finds usefulness in such applications as an electrostatic floating or an electrostatic floating and transportation using an electrostatic actuator, a precise positioning mechanism, a precision machining device, an anti-vibration device, an automobile engine valve, or a driving source for a high speed printer using a piezoelectric actuator, or a drive device for an electrostatic actuator, a piezoelectric actuator or the like.

### BRIEF DESCRIPTION OF THE DRAWINGS

FIG. 1 is a systematic diagram of an electrostatic actuator drive device in a first embodiment of the present invention.

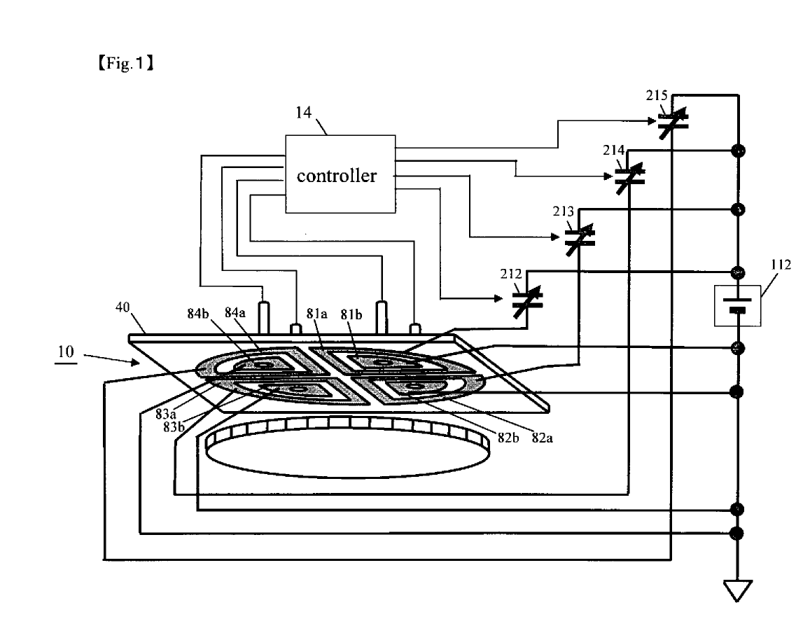

FIG. 2 is an equivalent circuit of the electrostatic actuator drive device in the first embodiment of the present invention.

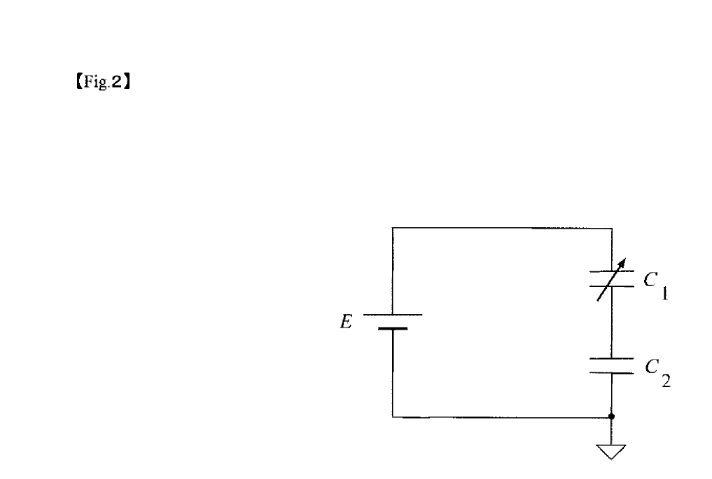

FIG. 3 illustrates the construction of an electrostatic actuator.

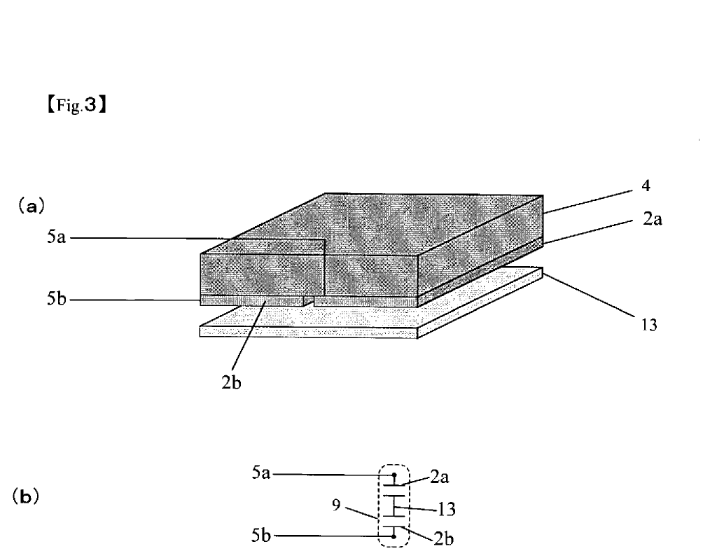

FIG. 4 is a first illustration of a variable capacitor structure in the first embodiment of the present invention.

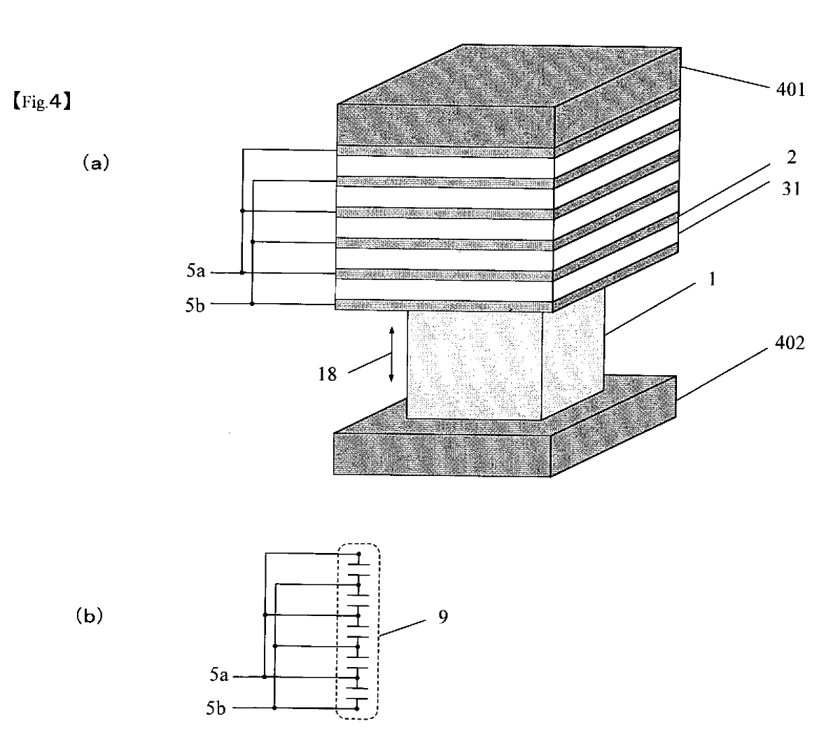

FIG. 5 is a second illustration of a variable capacitor structure in the first embodiment of the present invention.

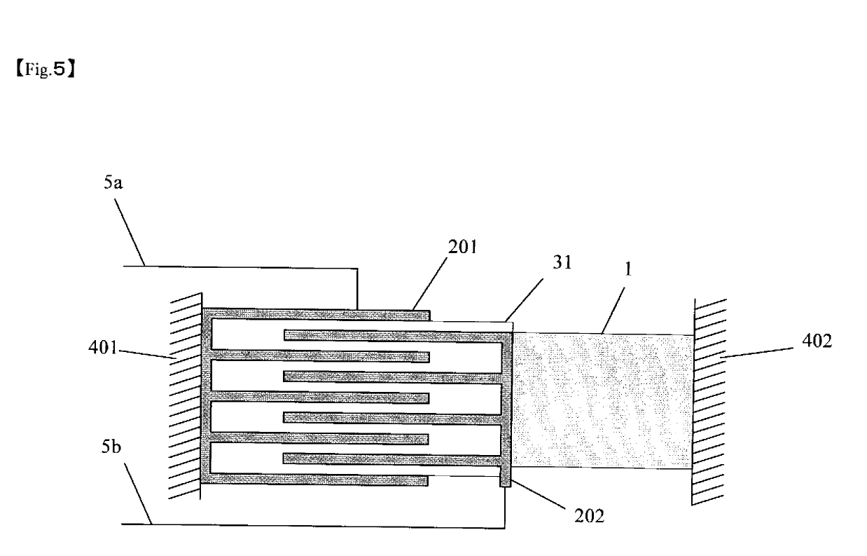

FIG. 6 is a third illustration of a variable capacitor structure in the first embodiment of the present invention.

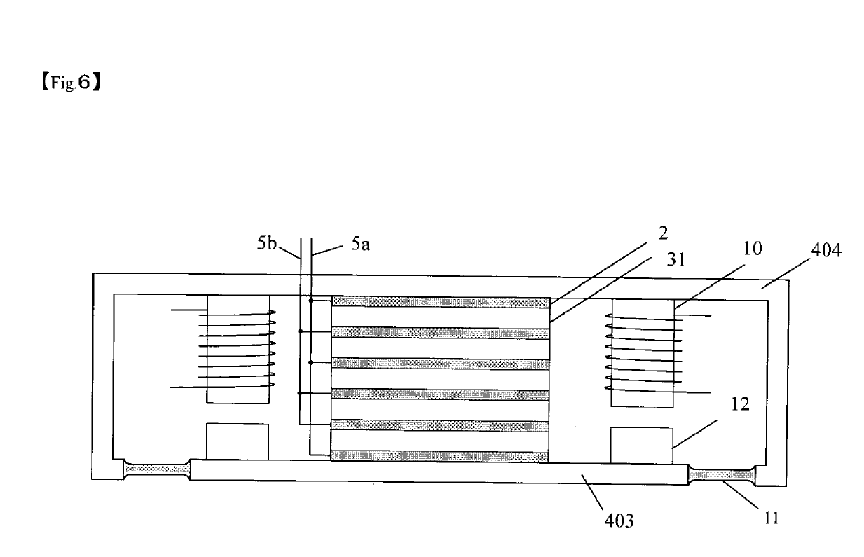

FIG. 7 is a fourth illustration of a variable capacitor structure in the first embodiment of the present invention.

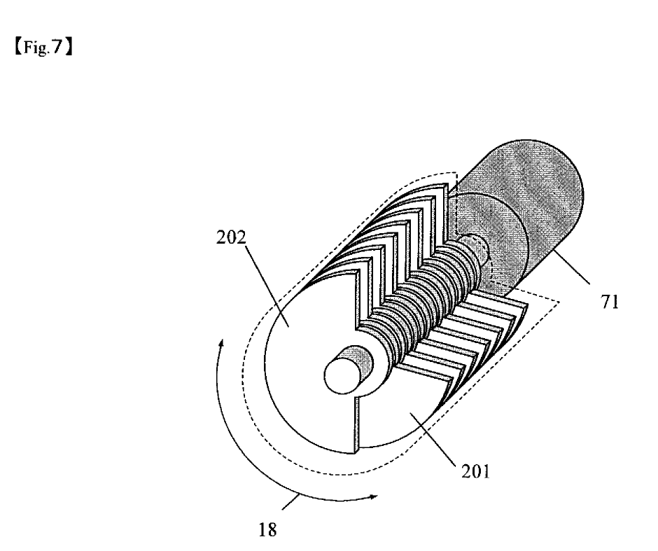

FIG. 8 is a fifth illustration of a variable capacitor structure in the first embodiment of the present invention.

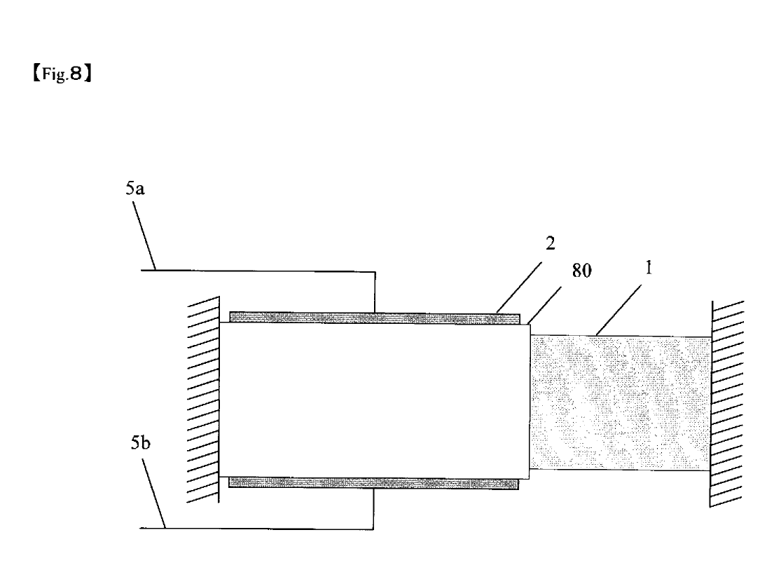

FIG. 9 is a sixth illustration of a variable capacitor structure in the first embodiment of the present invention.

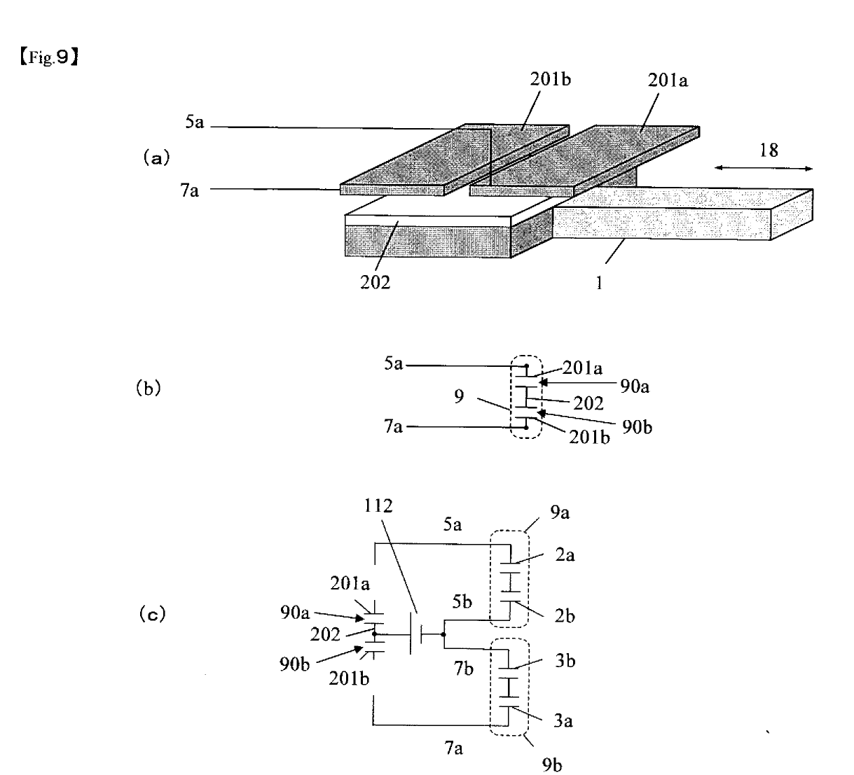

FIG. 10 shows the construction of a differential type electrostatic actuator.

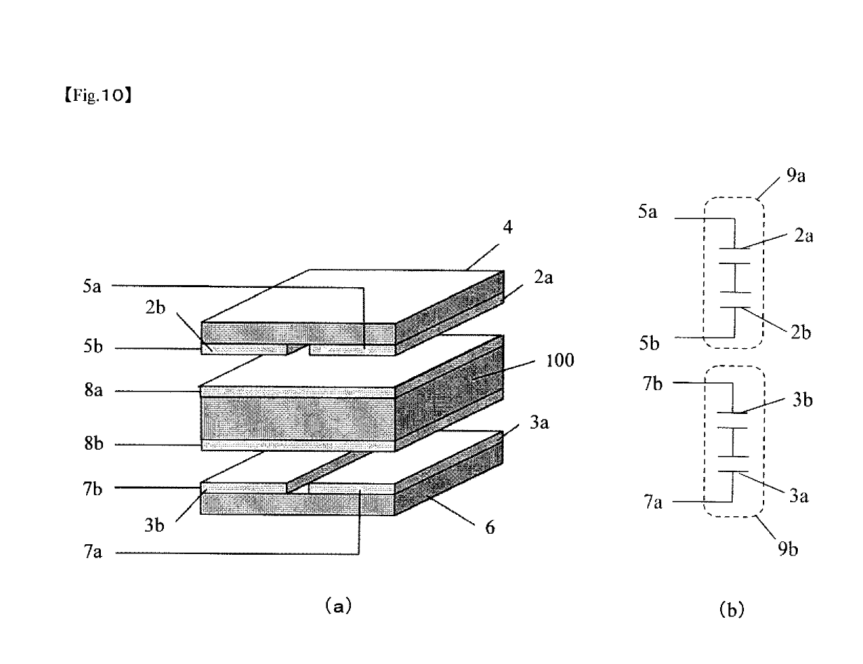

FIG. 11 is a seventh illustration of a variable capacitor structure in the first embodiment of the present invention.

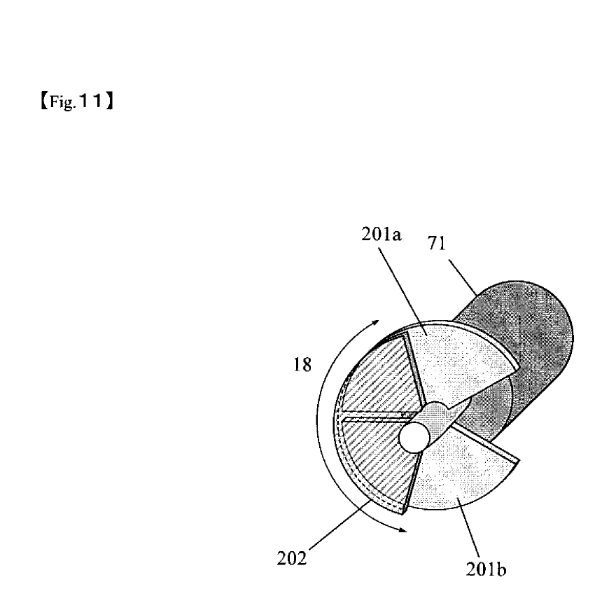

FIG. 12 is a circuit diagram of a circuit constituting a variable capacitor in the first embodiment of the present invention.

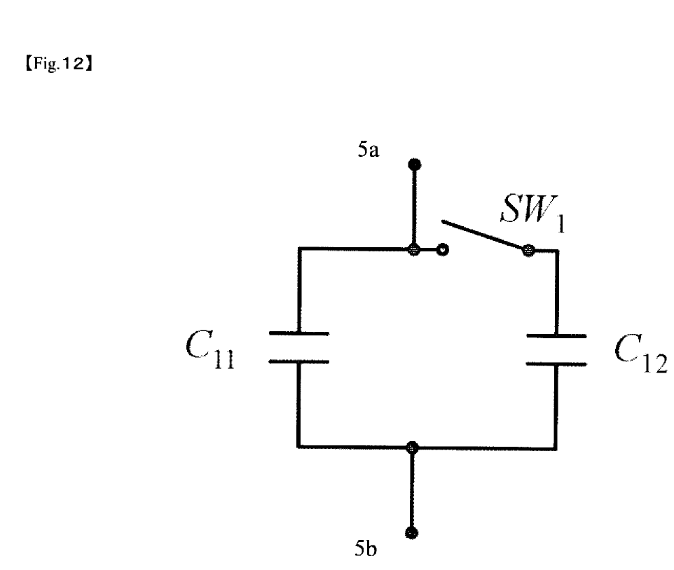

FIG. 13 is a timing chart to show the switching operation of the circuit constituting a variable capacitor in the first embodiment of the present invention.

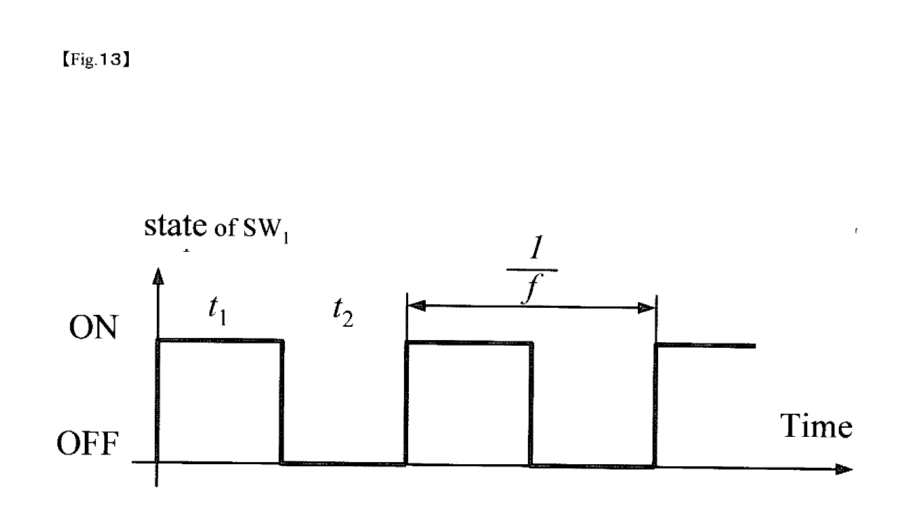

FIG. 14 illustrates experiment equipment that is used for measuring a propelling power of electrostatic floating in the first embodiment of the present invention.

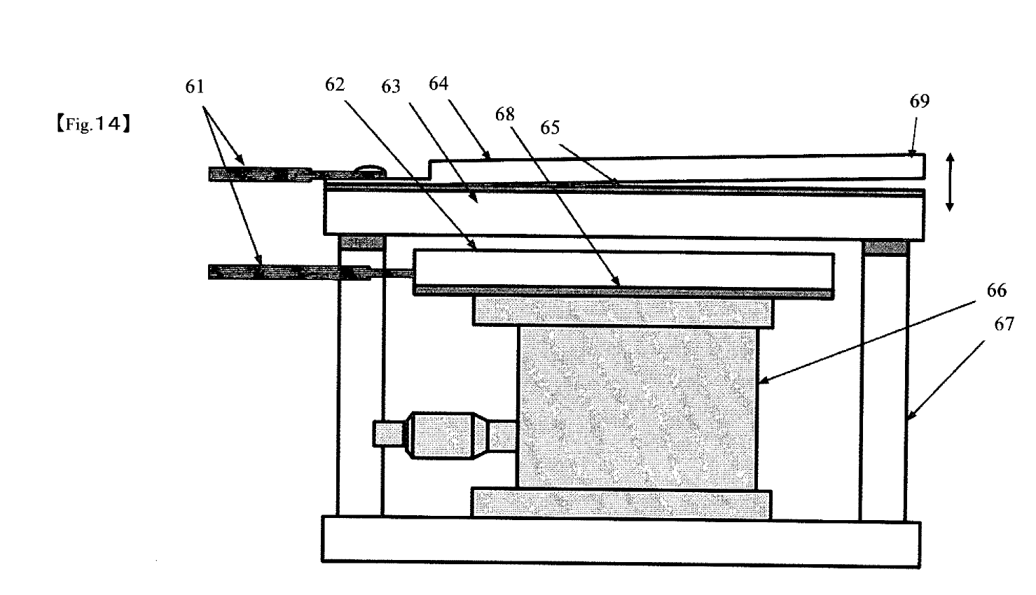

FIG. 15 is an equivalent circuit of the experiment equipment.

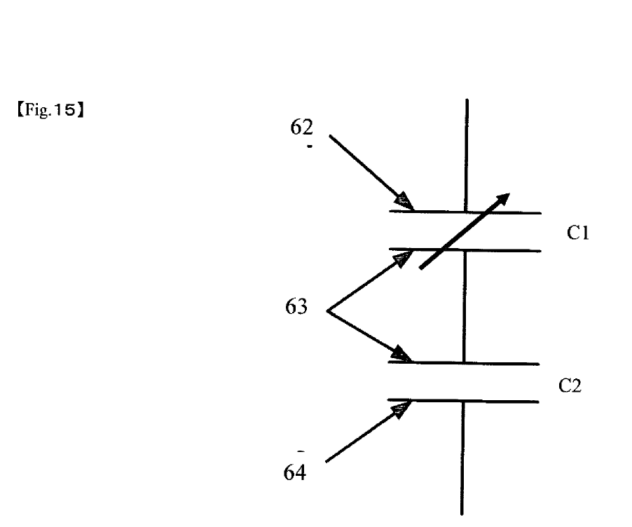

FIG. 16 is a graph to show the measurements of the propelling power of electrostatic floating.

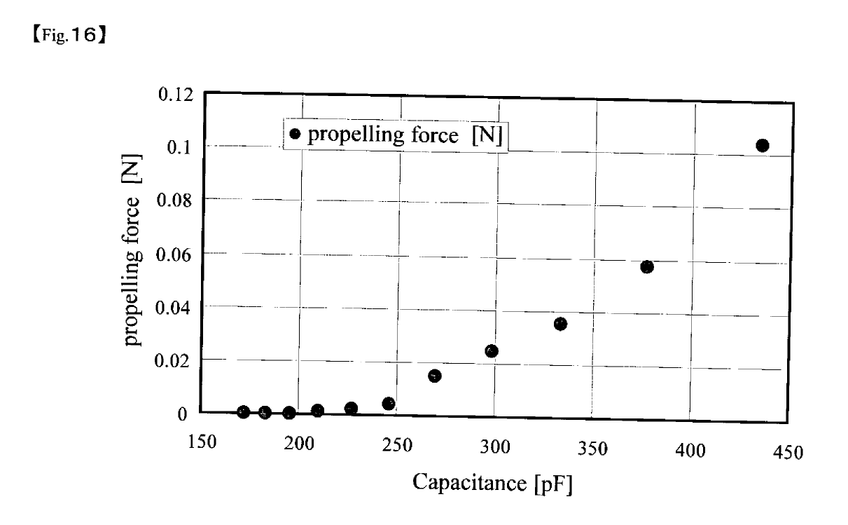

FIG. 17 illustrates experiment equipment for measuring a tracking performance of an electrostatic actuator in the first embodiment of the present invention.

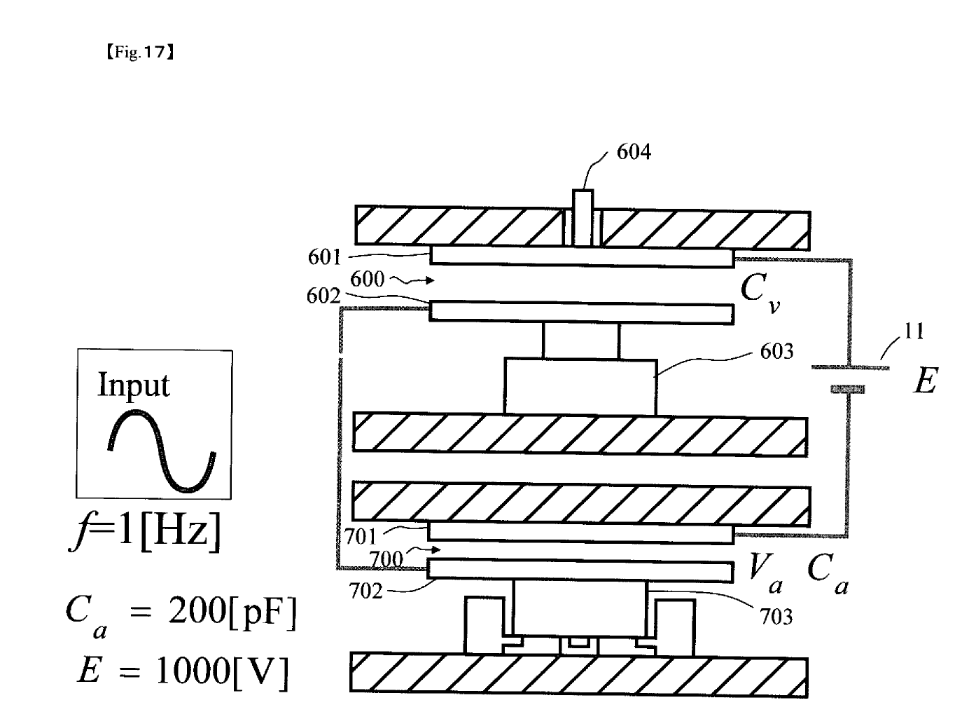

FIG. 18 (a) is a graph showing the change in capacitance (or electrostatic capacity) of the variable capacitor and (b) is a graph showing the change of the electrostatic actuator as measured by the experiment equipment as shown in FIG. 17.

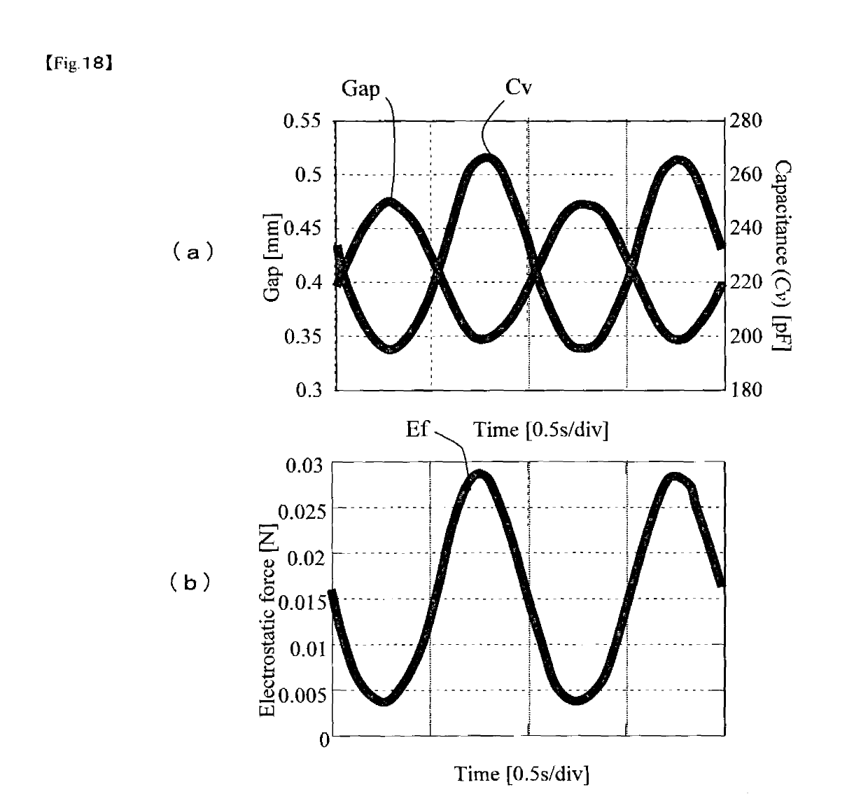

FIG. 19 is a graph in which the change in the variable capacitor and the change in the electrostatic actuator in FIG. 18 are superimposed.

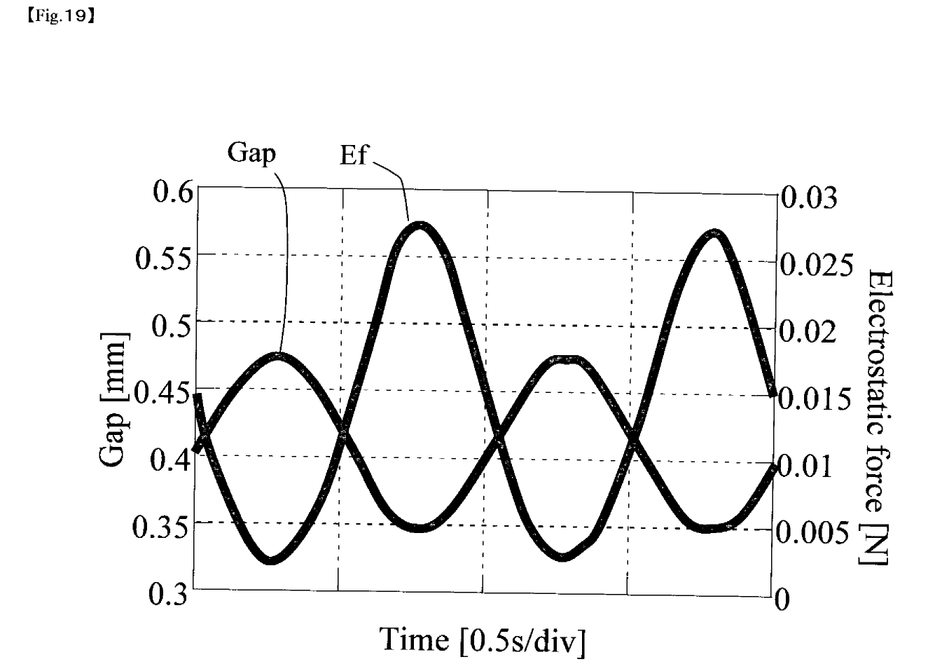

FIG. 20 shows the construction of an electrostatic floating and transportation device in the first embodiment of the present invention.

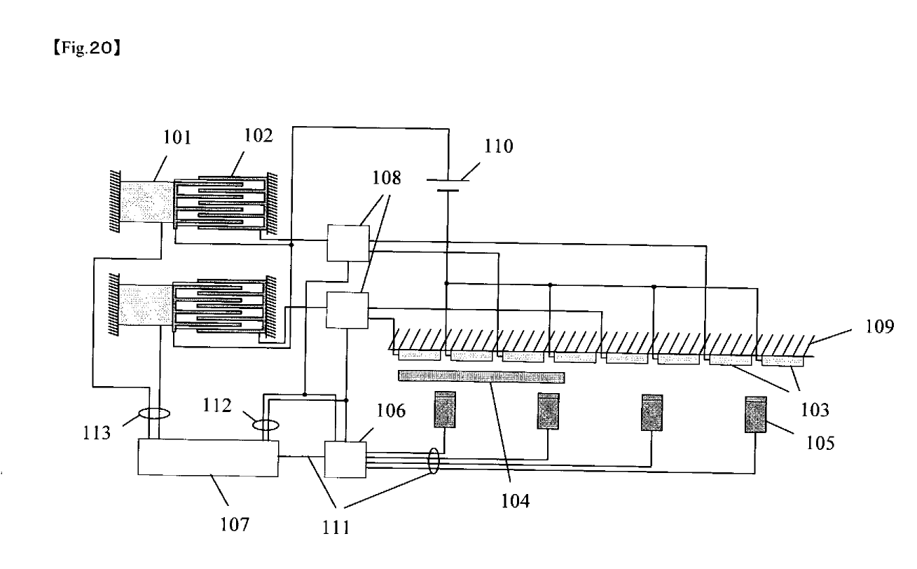

FIG. 21 is a systematic illustration of a drive device for a piezoelectric actuator in the first embodiment of the present invention.

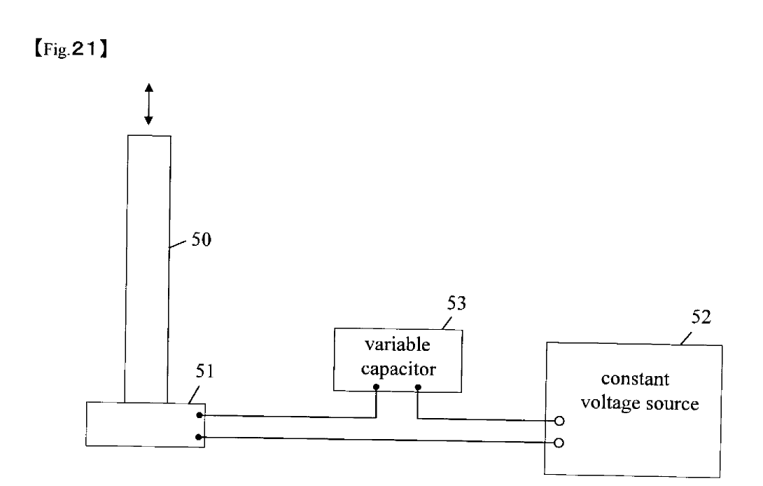

FIG. 22 shows a lamination type piezoelectric element of a piezoelectric actuator.

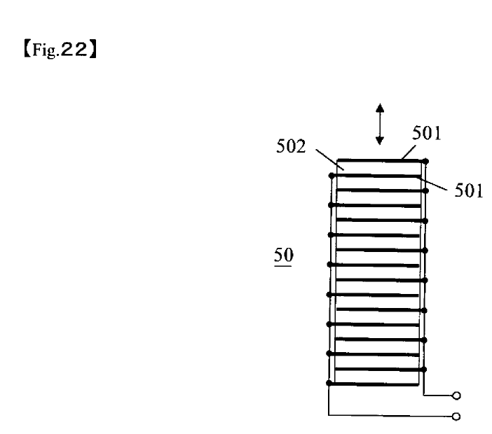

FIG. 23 is an equivalent circuit of a drive device for a piezoelectric actuator in the first embodiment of the present invention.

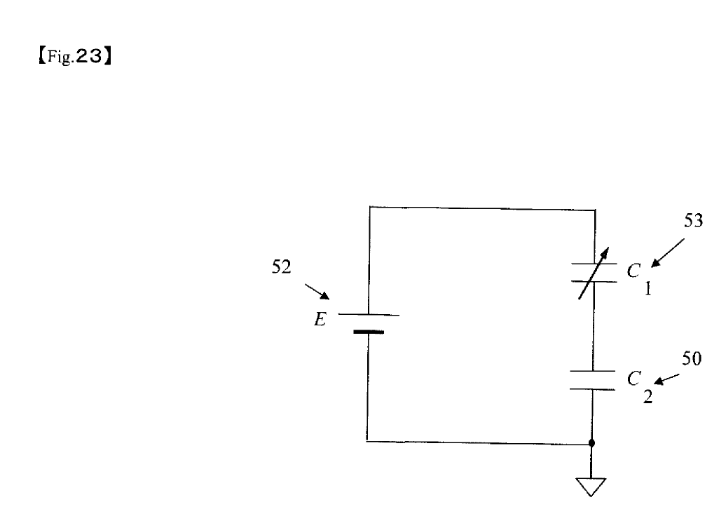

FIG. 24 is an equivalent circuit of a drive device in case of taking the internal resistance of a voltage source into consideration.

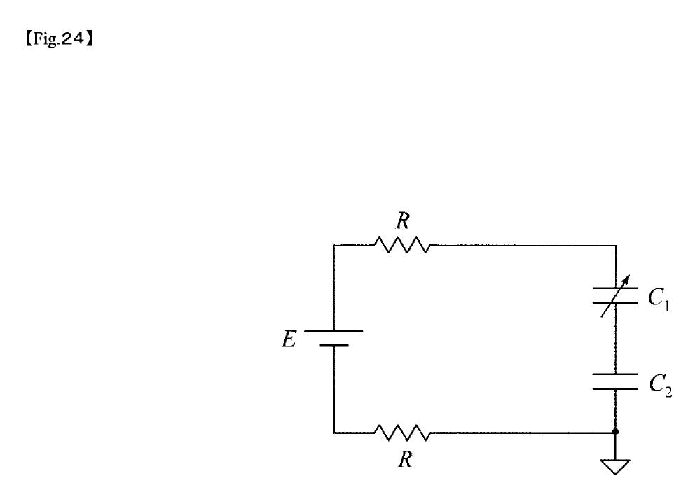

FIG. 25 is an equivalent circuit of an electrostatic actuator drive device in a second embodiment of the present invention.

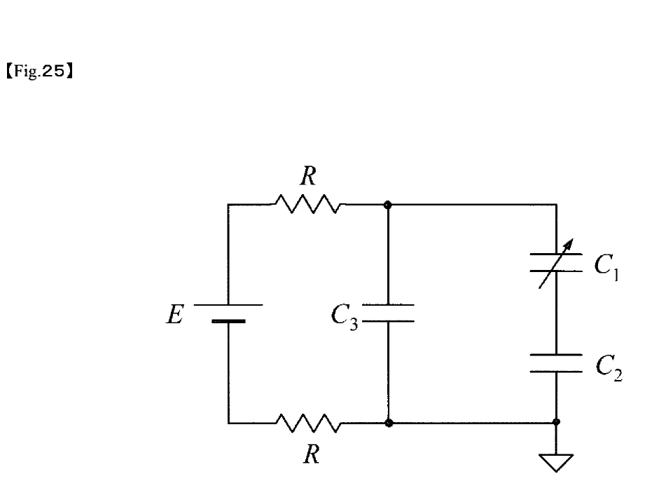

FIG. 26 is an equivalent circuit of the drive device in the second embodiment of the present invention immediately after changing the variable capacitor.

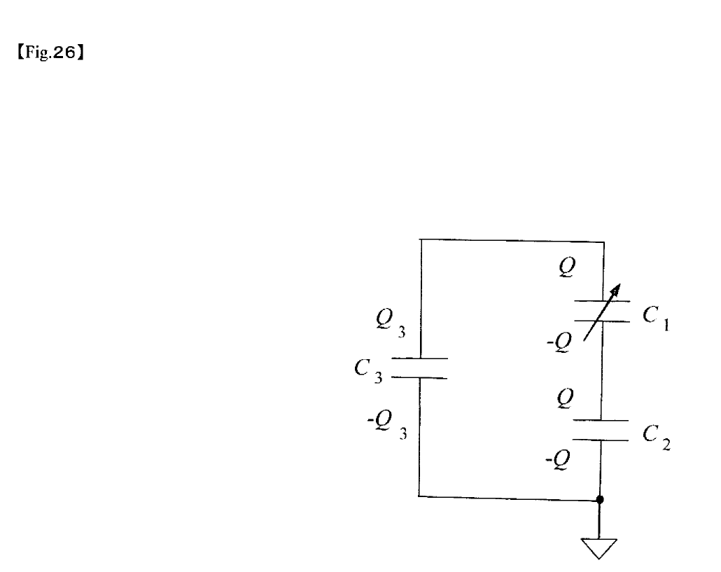

FIG. 27 shows the principle of a conventional electrostatic floating device.

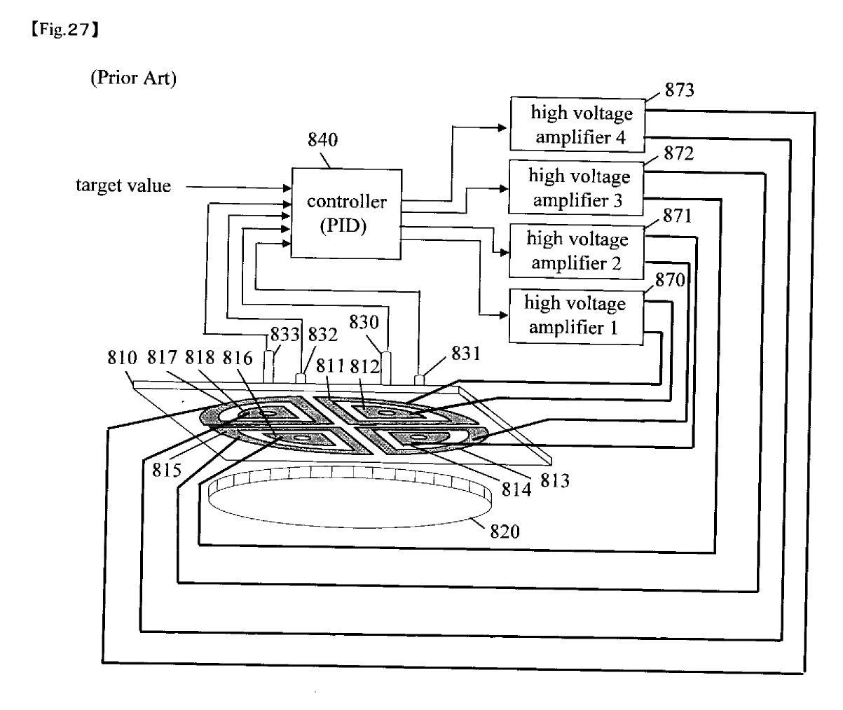

FIG. 28 shows the principle of a conventional electrostatic floating and transportation device.

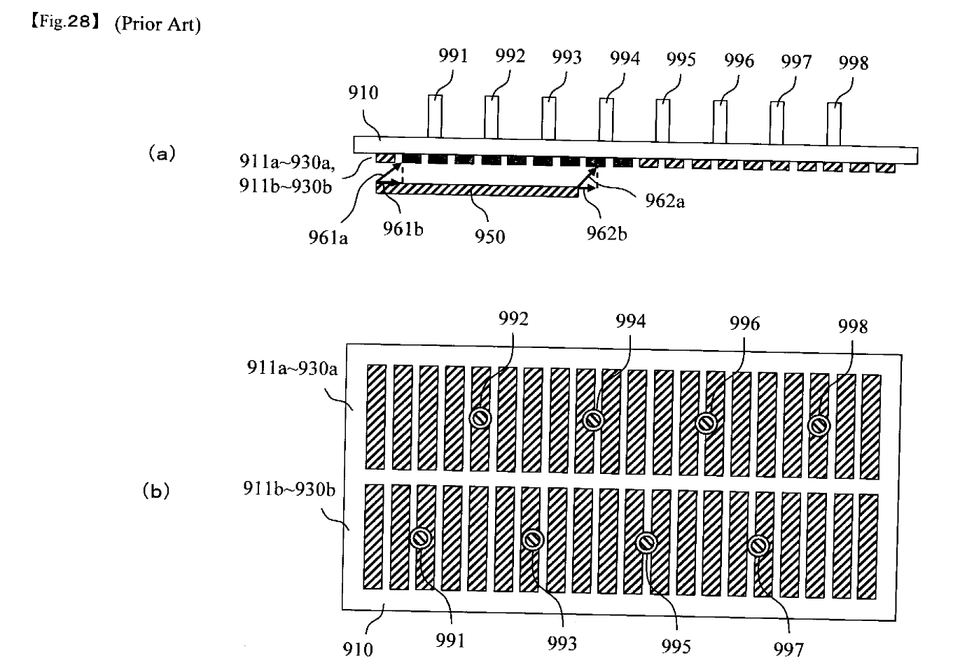

### DESCRIPTION OF REFERENCE NUMERALS

1 actuator
2 electrode
2a, 2b electrodes
3a, 3b electrodes
4 armature
5a, 5b electrode terminals
7a, 7b electrode terminals
8a, 8b electrodes
9 virtual capacitor
10 electrostatic actuator
11 constant voltage source
12 variable capacitor
13 floating member
14 controller
18 moving direction
31 dielectric member
50 piezoelectric device
51 base portion
52 constant voltage source
53 variable capacitor
62 floating conductor
63 electrically conductive plate
64 moving plate
65 dielectric layer
66 alignment stage
67 supporting pole
68 insulator layer
69 moving plate end portion
71 rotary type actuator
80 piezoelectric member
81a-84a electrodes
81b-84b electrodes
90 virtual capacitor
90a virtual capacitor
90b virtual capacitor
100 insulator
101 actuator
102 variable capacitor
103 electrode
104 member to be transported
105 displacement sensor
106 sensor combiner
107 controller
108 distributor
109 base
110 constant voltage source
112 constant voltage source
201 fixed electrode
201a, 201b fixed electrodes
202 movable electrode
212-215 variable capacitor
401 base
402 base
501 electrode
502 piezoelectric member
600 variable capacitor
601 fixed electrode
602 movable electrode
603 VOC
604 gap sensor
700 electrostatic actuator
701 fixed electrode
702 movable electrode
703 load cell
810 stator
811-818 electrodes
820 floating member
830-833 displacement sensors
840 controller
870-873 high voltage amplifiers
910 stator
911a-930a, 911b-930b comb-like electrodes
950 member to be transported
991-998 displacement sensors

1. An equivalent-capacitance-type actuator drive device comprising a variable capacitor connected in series with an equivalent-capacitance-type actuator, and a constant voltage source for applying a voltage between the series connection of the equivalent-capacitance-type actuator and the variable capacitor so that the voltage to be applied across the equivalent-capacitance-type actuator is adjusted by varying the capacitance of the variable capacitor.

2. An equivalent-capacitance-type actuator drive device of claim 1, further comprising a capacitor having a large capacitance and connected in parallel with the constant voltage source.

3. An equivalent-capacitance-type actuator drive device of claim 1, wherein the equivalent-capacitance-type actuator is an electrostatic actuator.

4. An equivalent-capacitance-type actuator drive device of claim 1, wherein the equivalent-capacitance-type actuator is a piezoelectric actuator.

5. An equivalent-capacitance-type actuator drive device of claim 1, further comprising drive means for varying the capacitance of the variable capacitor in response to a control signal, wherein the driving means changes the distance between the electrodes of the variable capacitor.

6. An equivalent-capacitance-type actuator drive device claim 1, further comprising driving means for varying the capacitance of the variable capacitor in response to a control signal, wherein the driving means changes the opposed area between the electrodes of the variable capacitor.

7. An equivalent-capacitance-type actuator drive device of claim 1, further comprising driving means for varying the capacitance of the variable capacitor in response to a control signal, wherein the driving means changes the strain to be applied to a piezoelectric member between electrodes of the variable capacitor.

8. An equivalent-capacitance-type actuator drive device of either one claim 1, further comprising driving means for varying the capacitance of the variable capacitor in response to a control signal, wherein the driving means causes to move a movable member constituting a capacitance between a plurality of electrodes of the variable capacitor, thereby differentially changing the capacitances between the plurality of electrodes.

9. An equivalent-capacitance-type actuator drive device of claim 1, wherein the variable capacitor comprises a plurality of parallel connected fixed capacitors, and a switch for periodically connecting or disconnecting a part of the fixed capacitors for varying the combined capacitance of the plurality of fixed capacitors as a result of changing the connection and disconnection ratio of the switch.

10. A voltage control method for controlling the voltage to be applied to a capacitive device, comprising the steps of:
connecting a variable capacitor in series with the capacitive device;
applying a voltage across the series connection of the capacitive device and the variable capacitor; and
varying the capacitance of the variable capacitor for controlling the voltage to be applied to the capacitive device.

11. A voltage control method of claim 10, further comprising the step of connecting a capacitor having a sufficiently larger capacitance than those of the capacitive device and the variable capacitor.

12. A voltage control method of claim 10, wherein varying the capacitance of the variable capacitor is implemented by periodically connecting a fixed capacitor in parallel with another fixed capacitor by way of a switch with the ON-OFF ratio of the switch being adjusted in response to a control signal.
